(19) United States
(12) Patent Application Publication
(10) Pub. No.: US 2023/0099009 A1
(43) Pub. Date: Mar. 30, 2023

(54) HEAT EXCHANGER CORE DESIGN

(71) Applicant: Hamilton Sundstrand Corporation, Charlotte, NC (US)

(72) Inventors: Dawid LEWANDOWSKI, Lubin (PL); Rafal LEWANDOWSKI, Mrowiny (PL)

(21) Appl. No.: 17/950,385

(22) Filed: Sep. 22, 2022

(30) Foreign Application Priority Data
Sep. 24, 2021 (EP) 21461599.9

(51) Int. Cl. F28D 7/16

(52) U.S. Cl. CPC F28D 7/1692

(57) ABSTRACT

A method of forming fluid flow channels for a heat exchanger core includes additively manufacturing the channels such that each channel includes a straight axial fluid path portion (A) extending from one end of the channel to the other and that the cross-sectional shape of the channel varies along its length to form curved contact surfaces for the fluid as it flows along the channel, while keeping the cross-sectional area constant along each channel.

### CROSS-REFERENCE TO RELATED APPLICATIONS

This application claims priority to European Patent Application No. 21461599.9 filed Sep. 24, 2021, the entire contents of which is incorporated herein by reference.

### TECHNICAL FIELD

The present disclosure is concerned with the design and manufacture of a core of a heat exchanger using additive manufacture.

### BACKGROUND

Heat exchangers typically work by the transfer of heat between fluid flowing in parallel channels defined by metal plates of a heat exchanger core. Thermal properties are improved by the introduction of turbulence in the flow channels and so, conventionally, a heat exchanger core comprises corrugated metal plates arranged adjacent each other so as to define corrugated flow channels for the heat exchange fluids.

Additive manufacture, or 3D printing, has recently become a preferred manufacturing method for many parts and components due to the fact that it is relatively quick and low cost and allows for great flexibility in the design of new components and parts. Due to the fact that components and parts made by additive manufacture (AM) can be quickly made in a custom designed form, as required, AM also brings benefits in that stocks of components do not need to be manufactured and stored to be available as needed. AM parts can be made of relatively light, but strong materials. As AM is becoming more popular in many industries, there is interest in manufacturing heat exchangers using AM.

Although AM has many advantages in the manufacture of heat exchanger parts, the complex, corrugated shape of the channels means that it is difficult to fully remove the powder that results from the AM process from the corrugated channels. For best heat exchange properties, the channels need to be narrow and corrugated. The typical process of vibrating and rotating the plates, then rinsing fluid through the channel to remove the powder does not work well when the channel has a narrow, corrugated shape as the air/fluid cannot easily pass through the channel and remove all of the powder. Deposits of powder can, therefore, remain in the corrugations. AM can be used to advantage for manufacturing cores with straight channels, since the residual powder can be easily removed in the conventional way, but such channels then create less turbulence in the heat exchange fluid flowing through the channels and are less effective in terms of heat exchange properties.

There is a need for a method of manufacture, and design of fluid flow channels for a heat exchanger using additive manufacture, which allows for turbulence in the flow of fluid along the channels but also enables powder from the additive manufacture process to be effectively removed.

### SUMMARY

According to the disclosure, there is provided a method of forming fluid flow channels of a heat exchanger core comprising additively manufacturing the channels such that each channel includes a straight axial fluid path portion extending from one end of the channel to the other and that the cross-sectional shape of the channel varies along its length to form curved contact surfaces for the fluid as it flows along the channel, while keeping the cross-sectional area constant along each channel.

A method of manufacturing a heat exchanger core having an array of such fluid flow channels is also provided as defined in claims 4 and 5.

According to the disclosure, there is also provided an additively manufactured arrangement of fluid flow channels for a heat exchanger, comprising an array of channels for the flow of hot and cold fluid in a heat exchange configuration, wherein each channel includes a straight axial fluid path portion extending from one end of the channel to the other and wherein the cross-sectional shape of each channel varies along its length to form curved contact surfaces for the fluid as it flows along the channel, while keeping the cross-sectional area constant along each channel.

### BRIEF DESCRIPTION OF THE DRAWINGS

Examples of the method and design of the disclosure will be described with reference to the drawings. It should be noted that variations are possible within the scope of the claims.

FIGS. 1A and 1B show perspective views taken at two different locations along fluid flow channels according to this disclosure.

FIG. 1C is a side view of the channels of FIGS. 1A and 1B.

FIGS. 2A and 2B show two possible heat exchanger core designs using channels according to the disclosure.

FIG. 3 shows a view of channels being manufactured by additive manufacturing according to the disclosure.

FIG. 4 shows an alternative view of channels being manufactured by additive manufacturing according to the disclosure.

FIG. 5 is a perspective view of channels manufactured by additive manufacturing according to the disclosure.

### DETAILED DESCRIPTION

The heat exchanger core channels according to the disclosure are formed to have a clear axial path extending from one end of the channel to the other but are shaped to have a varying geometry along the length of the channel to provide edges or curves for the fluid flow to create turbulence in the flow as the fluid flows along the channel. The overall average cross-sectional area of the channel remains the same along the channel length. The channels do not, therefore, have any corrugated sections and, instead, a straight axial path is provided, which simplifies powder removal.

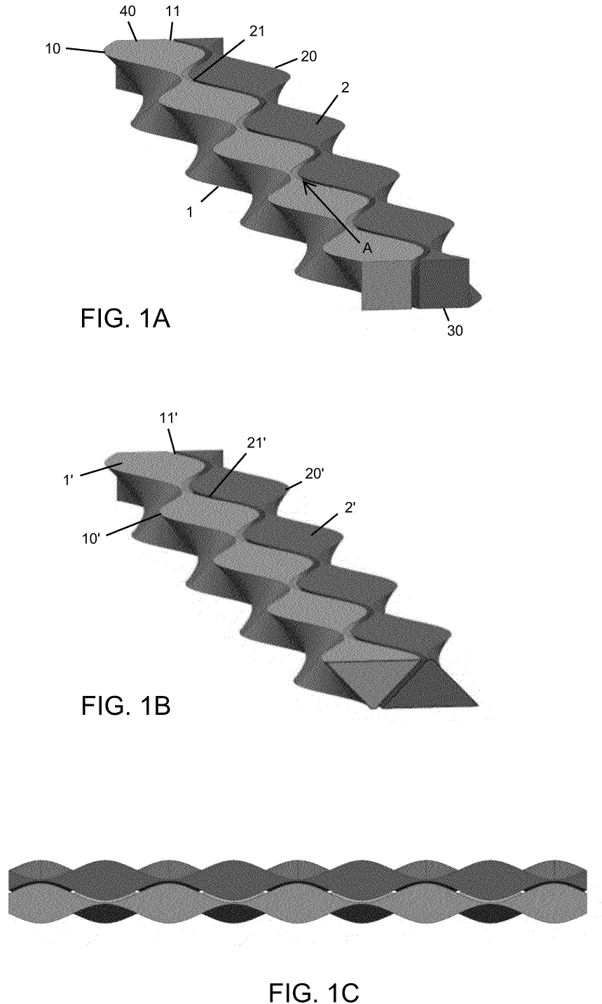

FIGS. 1A and 1B show, at two axial locations, how the fluid channels can be designed according to the disclosure. In each example, one channel (here 1, 1') is for the flow of cold fluid and the other (2, 2') is for the flow of hot fluid. As can be seen, in each example a straight axial fluid flow path A is defined along the length of the channel from one end 30 to the other end 40, but the outer walls 10, 11; 10',11'; 20, 21; 20', 21' define a shape that varies along the length of the channel thus defining channel walls whose angles vary along the length of the channel in relation to the fluid flow direction. The variations are such that the overall cross-sectional area of the flow channels remains the same, thus reducing the potential for pressure drop in the core, but the shapes induce fluid turbulence and therefore improve thermal efficiency.

Although one possible design of channel is shown, other shapes and configurations are also possible. Because the channels of the disclosure are made using additive manufacturing, the printing process may impose limitations on the angle that it is possible to produce. For AM manufacturing, consideration needs to be given, e.g. to the overall weight of the resulting product to avoid the channels being too heavy and collapsing. At present, it is thought that the angle of the side walls defining the turbulence-inducing shape should not exceed 45 degrees due to current 3D printing constraints.

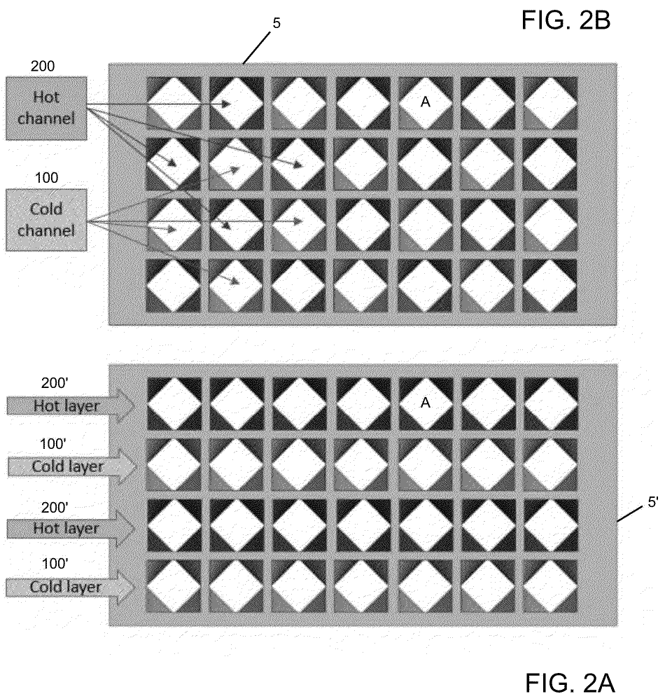

The resulting channels will, as mentioned above, have a straight axial path A extending all the way through the channels — i.e. one can see all the way through the channel from end-to-end — which is not the case with the classical corrugated channels. This feature can be seen in FIGS. 2A and 2B which show two possible examples of how hot and cold channels, according to the disclosure, can be arranged relative to each other.

FIG. 2B shows an example corresponding to the classical pattern where the core 5' comprises alternating rows of cold channels 100' and hot channels 200'. FIG. 2B shows an alternative arrangement, found to have particularly good heat exchange properties, in which cold channels 100' and hot channels 200 are alternated in the horizontal and vertical directions of the core 5 in a checkerboard pattern. Because the channels are formed using additive manufacturing, this alternative design and other alterative patterns become possible. In conventionally manufactured cores, only alternating rows are possible.

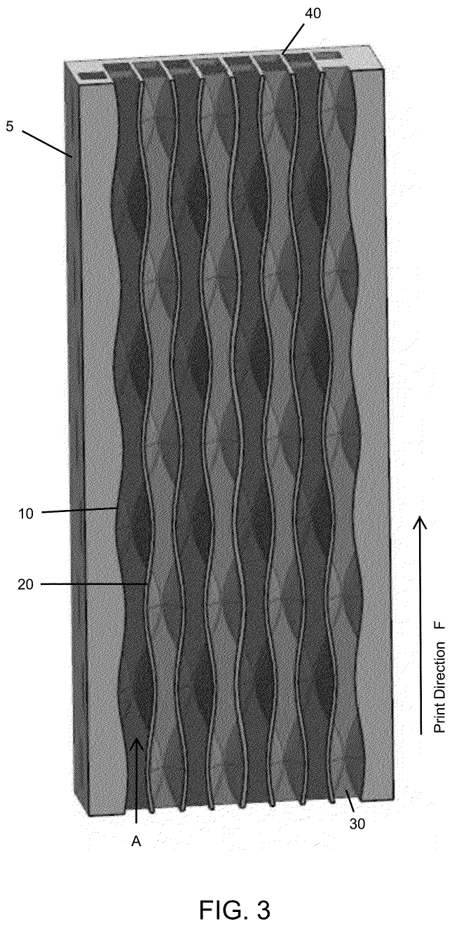

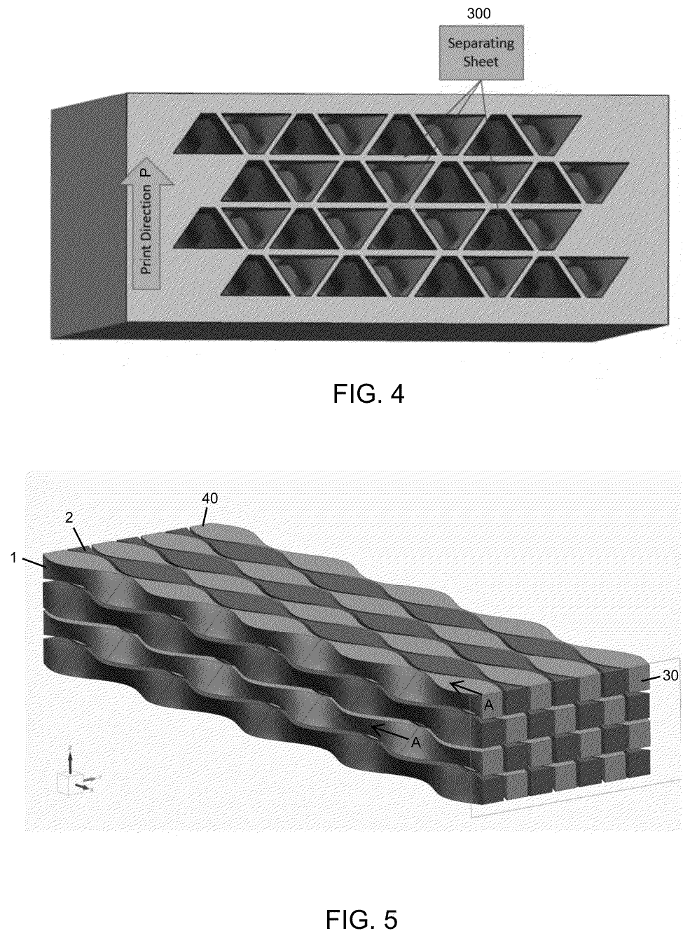

FIGS. 3 and 4 show how the channels can be formed (here using the example shapes of FIGS. 1A and 1B, respectively). The variable cross-section channel geometry is simple and has been found to be 3D-printing friendly.

FIG. 3 shows how channels can be printed in the fluid flow direction F. The example shown here is for a square or rectangular cross-section, and shows the straight axial path A right through the channels and the shaped channel walls to induce turbulence, as described above. Additive manufacture is use to build up the structure of the core 5 and define the channels from the bottom up, in the fluid flow direction F. This procedure can, of course, be used for any channel shape, size or length. Printing in the fluid flow direction F will result in smooth geometry transitions without any overhang. The print direction could also be directly opposite the fluid flow direction F.

Alternatively, as shown in FIG. 4, the core can be printed in a direction P perpendicular to the fluid flow, defining the side walls 10, 11, 10', 11', 20, 21, 20', 21' at the appropriate angles (within the capabilities of the printer. In this way, separating sheets 300 between the channel layers will cause overhangs. This can be mitigated by reducing the distance between the side walls.

An example of the resulting channels can be seen in FIG. 5.

Again, because additive manufacture is used to produce the channels according to this disclosure, the specific geometries and dimensions can be easily modified according to requirements. Different shapes will give rise to different flow patterns and turbulence within the channels. The more changes in shape, and the tighter the curves the fluid has to flow past, the greater the turbulence but more complex shapes are less efficient to print. For any particular design, a compromise can be reached between turbulence and printing simplicity, depending on the factors that govern the design.

The principle feature is that the additively manufactured channels have an axially extending path all the way through the channel and that the shape of the channel varies along its length. These features combine to enable effective powder removal required for additively manufactured cores and to provide turbulence in the fluid flow channel. By using additive manufacture, designs can be varied for different flow configurations and/or different patterns of channels, the pitch of the shaped parts of the channels can be adjusted to vary thermal performance and designs can be easily scaled up or down.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A method of forming fluid flow channels for a heat exchanger core, the method comprising:
additively manufacturing the channels such that each channel includes a straight axial fluid path portion (A) extending from one end of the channel to the other and that the cross-sectional shape of the channel varies along its length to form curved contact surfaces for the fluid as it flows along the channel, while keeping the cross-sectional area constant along each channel.

2. The method of claim 1, wherein each channel includes outer walls that define a shape that varies from one end of the channel to the other and wherein the straight axial fluid path portion (A) is defined between the outer walls.

3. The method of claim 2, wherein the outer walls define a shape such that an angle between the outer walls and the straight axial fluid path portion varies along the length of the channel in relation to the direction of fluid flow through the channel from one end to the other.

4. A method of manufacturing a heat exchanger core, comprising:
forming a plurality of fluid flow channels as claimed in claim 1 by additive manufacturing,
the plurality of fluid flow channels comprising alternate layers of hot channels and cold channels.

5. The method of claim 4, whereby the channels are formed from the bottom up in the fluid flow direction.

6. The method of claim 4, whereby the channels are formed in a direction perpendicular to the fluid flow direction.

7. A method of manufacturing a heat exchanger core, comprising:
forming a plurality of fluid flow channels as claimed in claim 1 by additive manufacturing,
the plurality of fluid flow channels comprising alternate layers of channels, each layer comprising alternating hot and cold channels to result in a checkerboard pattern of hot and cold channels.

8. The method of claim 7, whereby the channels are formed from the bottom up in the fluid flow direction.

9. The method of claim 7, whereby the channels are formed in a direction perpendicular to the fluid flow direction.

10. An additively manufactured arrangement of fluid flow channels for a heat exchanger, comprising:
an array of channels for the flow of hot and cold fluid in a heat exchange configuration,
wherein each channel includes a straight axial fluid path portion extending from one end of the channel to the other and wherein the cross-sectional shape of each channel varies along its length to form curved contact surfaces for the fluid as it flows along the channel, while keeping the cross-sectional area constant along each channel.

11. The arrangement of claim 10, comprising alternating layers of hot and cold channels.

12. The arrangement of claim 10, comprising alternate layers of channels, each layer comprising alternating hot and cold channels to result in a checkerboard pattern of hot and cold channels.
